(19) United States
(12) Patent Application Publication
(10) Pub. No.: US 2009/0143095 A1
(43) Pub. Date: Jun. 4, 2009

(54) INTER-MODE INTERFERENCE PREVENTION IN A MULTIMODE WIRELESS DEVICE

(75) Inventor: Xuejun Zhang, Shanghai (CN)

Correspondence Address: Docket Clerk, P.O. Box 802432, Dallas, TX, 75380, US

(73) Assignee: ST WIRELESS SA, Geneva (CH)

(21) Appl. No.: 12/270,703

(22) Filed: Nov. 13, 2008

(30) Foreign Application Priority Data
Nov. 14, 2007 (EP) 07120661.9

(51) Int. Cl. H04M 1/00

(52) U.S. Cl. 455/552.1

(57) ABSTRACT

This invention relates to a device, a method, a computer program and a computer program product for a device capable of communicating in a first mode of wireless communication and a second mode of wireless communication simultaneously, wherein it is determined for each of at least one channel of a plurality of channels whether interference occurs between the first mode and the second mode; and wherein the channels which have been determined not to cause interference are stored in a list of preferable channels. For instance, in the case where the first mode represents a cellular communications mode, during a cell selection/reselection procedure of the first mode, instead of searching in the cell information stored for the PLMN, it will first search in the list of preferable channels when the second mode is active.

### CROSS-REFERENCE TO RELATED APPLICATION(S) AND CLAIM OF PRIORITY

This application claims priority under 35 U.S.C. § 119(a) to a European patent application filed in the European Patent Office on Nov. 14, 2007 and assigned Serial No. EP07120661.9, the entire disclosure of which is hereby incorporated by reference.

### TECHNICAL FIELD OF THE INVENTION

This invention relates to a device, a method, a computer program and a computer program product for a device capable of communicating in a first mode of wireless communication and a second mode of wireless communication simultaneously.

### BACKGROUND OF THE INVENTION

There are two types of radio resource management strategy in wireless communication systems: centralized and decentralized. The cellular network's spectrum is monopolistic, and its radio resource management is centralized: often a base station is responsible for allocating the available radio resources to its serving terminals in a specific geographical area. However, some wireless systems share spectrum with others and then adopt the decentralized radio resource management strategy. That sort of wireless communication system has an inherent capability to overcome co-existence interference. The typical examples are the numerous wireless equipments operating in the industrial, scientific and medical (ISM) frequency band, such as Bluetooth, Wi-Fi and Digital Enhanced Cordless Telecommunications (DECT), etc. In order to overcome the coexistence interference, they use Frequency Hopping Spread Spectrum (FHSS) and/or Direct Sequence Spread Spectrum (DSSS) aided with Carrier Sense Multiple Access with Collision Avoidance (CSMA/CA).

For a single mode terminal, i.e. a terminal which provides only one wireless function, the intra-system interference between its transmitter and receiver is overcome by frequency division and/or time division method. The inter-terminal interference is trivial because the space fading is quite large within a small distance. For example, the Minimum Coupling Loss (MCL) is 40 dB at 2 GHz wireless channel with 1 meter's interval as described in 3GPP TR 25.942 V6.4.0 (2005-03), “Radio Frequency (RF) system scenarios”, pp. 15.

For a multimode wireless terminal, which may have both decentralized and concentric radio resource modes, the interference scenario becomes more challenging. Since the space distance between the transceivers or antennas of the different modes is quite limited, the MCL is so small that it can be neglected. When different modes use neighboring frequency bands, the inter-mode interference can be quite large.

For instance, in China, the Time-Division—Synchronous Code Division Multiple Access (TD-SCDMA) has three frequency bands: 1880-1920 MHz (Band I), 2010-2025 MHz (Band II) and 2300-2400 MHz (Band III). The ISM frequency band in China is 2400 MHz-2483.5 MHz. So the third frequency band of the TD-SCDMA adjoins the ISM frequency band. Thus, for a TD-SCDMA/ISM multimode terminal or any other multimode terminal, there exists a great possibility that the dual modes interfere with each other when they are running at the same time.

### SUMMARY OF THE INVENTION

According to a first aspect of the present invention, a method for a device is described, wherein the device is configured or capable to communicate in a first mode of wireless communication and a second mode of wireless communication simultaneously, said first mode being associated with a plurality of channels. The method comprising determining for each of at least one channel of said plurality of channels whether interference occurs between the first mode and the second mode when the first mode uses the respective channel of said at least one channel, and storing the channels which have been determined not to cause interference in a list of preferable channels.

According to a second aspect of the present invention, a computer program product tangibly embodied in an information carrier is described. The computer program product comprising instructions that, when executed, cause at least one processor to perform operation of a method for a device, wherein the device is configured or capable to communicate in a first mode of wireless communication and a second mode of wireless communication simultaneously, said first mode being associated with a plurality of channels. The method comprising determining for each of at least one channel of said plurality of channels whether interference occurs between the first mode and the second mode when the first mode uses the respective channel of said at least one channel. The method further comprising storing the channels which have been determined not to cause interference in a list of preferable channels.

According to a third aspect of the present invention, a computer program operable to cause a processor to perform a method for a device is described, wherein the device is configured or capable to communicate in a first mode of wireless communication and a second mode of wireless communication simultaneously, said first mode being associated with a plurality of channels, the method comprising determining for each of at least one channel of said plurality of channels whether interference occurs between the first mode and the second mode when the first mode uses the respective channel of said at least one channel. The method further comprising storing the channels which have been determined not to cause interference in a list of preferable channels.

According to a fourth aspect of the present invention, a device configured or capable to communicate in a first mode of wireless communication and a second mode of wireless communication simultaneously is described, said first mode being associated with a plurality of channels. The device comprising a control unit configured to determine for each of at least one channel of said plurality of channels whether interference occurs between the first mode and the second mode when the first mode uses the respective channel of said at least one channel and configured to store the channels which have been determined not to cause interference in a list of preferable channels.

For instance, said the device may use a first transceiver/receiver/transmitter and a first antenna to communicate in the first mode, and the device may use a second transceiver/receiver/transmitter and a second antenna to communicate in the second mode. Furthermore, for instance said first and second transceiver/receiver/transmitter may be arranged in one transceiver/receiver/transmitter unit.

Thus, this device represents a multimode device configured to be driven in a first wireless mode and a second wireless mode simultaneously. It has further to be understood that said device may, for instance, comprise further wireless communication modes so that the present invention may be used to avoid inter-mode interference between any combinations of wireless communication modes which may used simultaneously by said device. For instance, this device may represent any multimode wireless terminal.

The control unit of the device may be used to control the first transceiver/receiver/transmitter and the second transceiver/receiver/transmitter.

The first mode is associated with a plurality of channels, wherein this plurality of channels may be arranged in a first frequency band or in several first frequency bands. For instance, said first mode may represent a Public Land Mobile Network (PLMN) like a cellular communications system, e.g. GSM, UMTS or any other cellular communication system, but said first mode may also represent any other communication system comprising at least two different frequency channels. Thus, for instance, said first mode may represent a cellular network having a centralized radio management.

Said second mode may, for instance, represent one out of the numerous wireless equipments operating in the industrial, scientific and medical (ISM) frequency band, such as Bluetooth, Wi-Fi, Digital Enhanced Cordless Telecommunications (DECT), or any other wireless system. Thus, said second mode may, for instance, represent a wireless network having a decentralized radio resource management.

For each of at least one channel of said plurality of channels, it is determined whether interference occurs between the first mode and the second mode at the device when the first mode uses the respective channel of said at least one channel. For instance, said inter-mode interference may be caused by transmission via the first antenna associated with the first mode and coupling through the second antenna in the signal path of the second mode and/or vice versa. This inter-mode interference is caused by the device itself.

This interference between the first mode and the second mode may, for instance, be determined by means of a practical measurement of the interference between the first mode and the second mode in the device, but any other suited way to determine the interference or a representative of the interference may also be applied. For instance, the frequency distance between the respective channel of said at least one channel and the frequency band of the second mode may be used as a kind of indicator for the interference between the first and second mode when this respective channel is used in order to determine said interference. Said practical measurement may be performed or controlled by said control unit.

Furthermore, for instance, each of said at least one channel of said plurality of channels may be associated with a different frequency. Further, for instance, at least one of said at least one different frequency may be outside of a frequency band of the second mode. Then, the channels which have been determined not to cause interference are stored in a list of preferable channels. The term interference has to be understood in such a way that those channels which cause less or no interference between the first mode and the second mode are stored in said list of preferable channel, i.e. an interference threshold—which may vary on the requirements of the first mode and/or the second more and/or on the requirements of the applications running on said modes—may, for instance, be used to determine and to store the channels causing interference below said threshold into the list of preferable channels.

Thus, for instance, those channels of said at least one channel having a safe frequency distance (SFDD) to said second mode may be determined and stored in said list of preferable channels.

This list of preferable channels can be used by the multimode device in order to select one of the channels in this list as an access channel for establishing a communication in the first mode when the second mode is active simultaneously. Thus, inter-mode interference caused by the device being driven in both the first mode and the second mode simultaneously can be avoided or minimized by using said list of preferable channels associated with the first mode in order to determine an access channel for establishing a communication in the first mode when the device is simultaneously driven in the second mode.

Thus, the present invention allows enabling a multimode device by overcoming the potential serious inter-mode radio frequency (RF) interference with very low complexity and cost.

Furthermore, in the case where said second mode is non-active, another access strategy in order to find an access channel in the first mode may be used. For instance, a further list of channels comprising the last time successful accessed channels of said first mode may be used to select an access channel for establishing a communication in the first mode.

According to an embodiment of the present invention, said determining is based on measuring an interference between the first mode and the second mode caused by the device for each of said at least one channel.

This measuring may be performed by means of test signals either transmitted in the first mode or transmitted in the second mode by the device in order to determine inter-mode interference by the device itself.

According to an embodiment of the present invention, said second mode represents a non-cellular communications mode.

For instance, said non-cellular communications mode may represent one out of the numerous wireless equipments operating in the industrial, scientific and medical (ISM) frequency band, such as Bluetooth, Wi-Fi, Digital Enhanced Cordless Telecommunications (DECT), or any other wireless system.

This non-cellular communications mode is associated with said frequency band of the second mode. This frequency band may be a frequency band which represents the actual access frequency band of said second mode. For instance, this frequency band may vary during operation in the second mode.

According to an embodiment of the present invention, said first mode represents a cellular communications mode.

For instance, said cellular communications mode may represent a GSM system, any variation of UMTS or any other cellular communication system.

According to an embodiment of the present invention, the channels which have been determined to cause interference are stored in a list of interference channels.

This allows classifying channels associated with the first mode into a list of preferable channels and a list of interference channels.

Thus, for instance, in the case where the device is both driven in the first mode and in the second mode simultaneously, then the list of preferable channels may be first used for determining an access channel and then the list of interference channels may be used.

According to an embodiment of the present invention, at least one channel is adjusted between the list of preferable channels and the list of interference channels during operation of the device.

For instance, said adjusting may depend on a variation of an operating state of the second mode or on other operating changes like different applications. Thus, due to changes of operating states of the device, the list of preferable channels and the list of interference channels may be adjusted, and the channel used for communication in the first mode can be changed in order to comply with variations in the operating state.

Or, for instance, in the case where said frequency band of the second mode changes during operation of the device, said adjusting of the list of preferable channels and the list of interference channels may be performed. Furthermore, for instance, in this case, the determining of channels in the list of preferable channels and the list of interference channels may be re-performed.

According to an embodiment of the present invention, a suitable channel of said plurality of channels is identified in order to establish a communication in the first mode via this suitable channel, wherein said identifying comprises: determining whether the second mode is active, and in the case where the second mode has been determined to be active, searching the list of preferable channels to identify a suitable channel in order to establish a communication in the first mode, and, only when no channel of the list of preferable channels is suitable, searching the list of interference channels to identify a suitable channel in order to establish a communication in the first mode.

Thus, it may be first determined whether the second mode of the device is active.

In the case where it has been determined that the second mode of the device is active, i.e. the device will now be driven in a multimode status, it is decided to proceed with searching the list of preferable channels to identify a suitable channel in order to establish a communication in the first mode.

Accordingly, during a channel selection/re-selection procedure of the first mode, the list of preferable channels is first searched when the second mode is active.

For instance, in the case where the first mode represents a cellular communications mode, during a cell selection/reselection procedure of the cellular mode, instead of searching in the cell information stored for the PLMN, it will search first the list of preferable channels when the second mode is active.

Thus, in the case where the second mode is active and an acquisition in the first mode has to be initiated so that the device is driven in the multimode, the device first searches those channels associated with the first mode that have been determined not to interfere with the second mode of the device (i.e., the channels in the list of preferable channels). If one of the channels of said list of preferable channels represents a suitable channel suited for an access in the first mode, then this channel is selected and may be used for access in the first mode by the device.

Accordingly, the serious inter-mode RF interference between the first and the second mode caused by the device can be overcome with a minimum complexity and cost since this selected channel does not interfere with the second mode.

Furthermore, if the search for a suitable channel in the list of preferable channels is not successful (i.e., no channel of this list can be used for a successful access in the first mode, which may, for instance, be caused by the fact that no channel in the list of preferable channels is available at the moment), then it is decided to proceed with an extended search for a suitable channel based on the list of interference channels in order to establish a communication in the first mode. For instance, this extended search may also comprise searching other channels of said plurality of channels associated with the first mode.

Thus, the list of preferable channels has a higher acquisition priority compared to the priority of the list of interference channels in the case where the device is both driven in the first mode and the second mode.

According to an embodiment of the present invention, said identifying further comprises the following: in the case where the second mode has been determined to be non-active, a suitable channel is identified in order to establish a communication in the first mode via this suitable channel by searching one of the following list of channels: a list of channels comprising both the channels of the list of preferable channels and the channels of the list of interference channels, and a list of channels comprising channels which have been used for earlier communications in the first mode, and a further list of channels comprising at least one of said plurality of channels.

Thus, in the case where the second mode is non-active, a single-mode communication acquisition may be performed in order to establish a communication in the first mode. For instance, this single-mode communication acquisition may use a list of channels comprising channels that have been used for earlier communications in the first mode but any other suited access method may be used to identify a suitable channel out of said plurality of channels associated with said first mode. As another example, in the case where the list of interference channels also has been generated, a list of channels comprising both the channels of the list of preferable channels and the channels of the list of interference may be used at single-mode communication acquisition, or any other suitable channels of the plurality channels of the first mode may be used for this single-mode communication acquisition.

Thus, in this single-mode (i.e., with non-active second mode), the entire performance of the first mode communication system is not influenced since the device still can utilize the channels of said plurality of channels near the frequency band of the second mode.

According to an embodiment of the present invention, a communication in the first mode is established based on said identified suitable channel.

According to an embodiment of the present invention, re-performing said identifying of a suitable channel is carried out during operation in the first mode, and when a new suitable channel has been identified, it switched to the new identified suitable channel in the first mode.

After the communication in the first mode has been established, it may be checked during operation of the device whether there is the necessity of determining a new channel for performing communication in the first mode. For instance, the signal level or signal-to-noise-ratio (SNR) may be checked, and when the signal level or SNR falls under a predetermined level, it may be decided to re-perform the identifying of a new suitable channel as explained above. Or, for instance, a change regarding the operating state of the second mode and/or the first mode at the device may trigger the necessity of identifying a new suitable channel. For example, the use of a new different frequency band in the second mode or activating/deactivating the second mode may represent such a change regarding the operating state of the second mode.

Furthermore, for instance, before said identifying of a new suitable channel is performed a re-organization of the list of preferable channels and the list of interference channels may be carried out. This re-organization may comprise adjusting at least one channel between the list of preferable channels and the list of interference channels, which may depend on variations of an operating state of the second mode or on other operating changes like different applications. Furthermore, for instance, said reorganization may comprise a complete re-determination of the list of preferable channels and the list of interference channels by means of a new interference classification of at least one channel of said plurality of channels associated with the first mode. Thus, during changes of operating states of the device, the list of preferable channels and the list of interference channels may be adopted and/or adjusted, and the channel used for communication in the first mode can be changed due to the variations in the operating state.

These and other aspects of the invention will be apparent from and elucidated with reference to the detailed description presented hereinafter. The features of the present invention and of its exemplary embodiments as presented above are understood to be disclosed also in all possible combinations with each other.

### BRIEF DESCRIPTION OF THE FIGURES

In the figures show:

FIG. 1 illustrates a flowchart of an exemplary first embodiment of a method according to the present invention;

FIG. 2 illustrates a flowchart of an exemplary second embodiment of a method according to the present invention;

FIG. 3a illustrates a flowchart of an exemplary third embodiment of a method according to the present invention;

FIG. 3b illustrates a flowchart of an exemplary fourth embodiment of a method according to the present invention configured to be used by the present invention;

FIG. 4 illustrates an exemplary embodiment of a device according to the present invention; and

FIG. 5 illustrates an exemplary handover between different channels in the first mode according to the present invention.

### DETAILED DESCRIPTION OF THE INVENTION

In the following detailed description of the present invention, exemplary embodiments of the present invention will be described in the context of multimode devices.

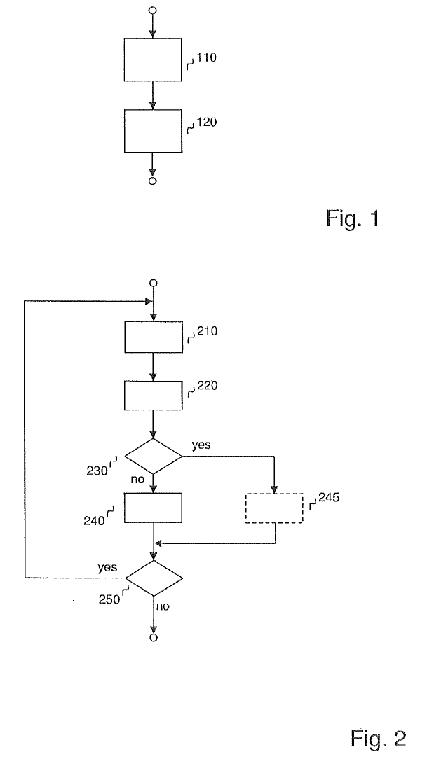

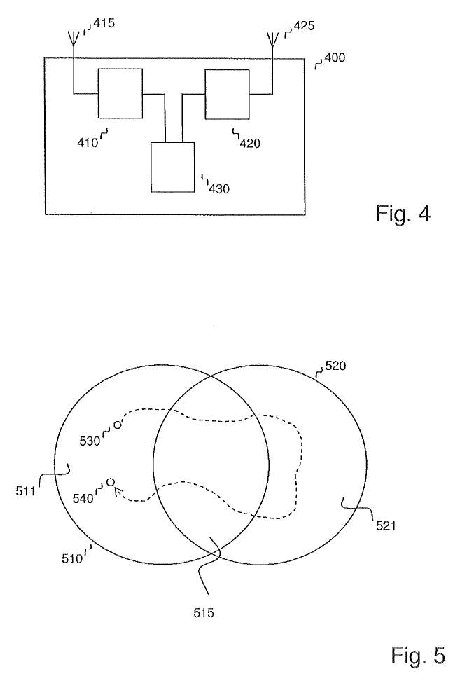

FIG. 1 depicts a first exemplary embodiment of a method according to the present invention. This exemplary method will be explained along with the exemplary embodiment of a device 400 according to the present invention depicted in FIG. 4.

This method may be applied for any device 400 capable of communicating in a first mode of wireless communication and a second mode of wireless communication simultaneously. For instance, said the device 400 may use a first transceiver/receiver/transmitter 410 and a first antenna 415 to communicate in the first mode, and the device 400 may use a second transceiver/receiver/transmitter 420 and a second antenna 425 to communicate in the second mode. Furthermore, for instance, said first transceiver/receiver/transmitter 410 and said second first transceiver/receiver/transmitter 420 may be arranged in a single first transceiver/receiver/transmitter unit (not depicted in FIG. 4).

Thus, this device 400 represents a multimode device 400 configured to be driven in a first wireless mode and a second wireless mode simultaneously. It is also understood that said device may, for instance, comprise further wireless communication modes so that the present invention may be used to avoid inter-mode interference between any combinations of wireless communication modes, which may used simultaneously by said device 400. For instance, this device 400 may represent any kind of multimode wireless terminal.

The device 400 may further comprise a control unit 430 in order to control the first transceiver/receiver/transmitter 410 and the second transceiver/receiver/transmitter 420. This control unit 430 may further be used to perform the method according to present invention.

The first mode is associated with a plurality of channels, wherein the plurality of channels may be arranged in a first frequency band or in several first frequency bands. For instance, said first mode may represent a Public Land Mobile Network (PLMN) like a cellular communications system (e.g., GSM, UMTS or any other cellular communication system), but said first mode may also represent any other communication system comprising at least two different frequency channels. Thus, for instance, said first mode may represent a cellular network having a centralized radio management.

Said second mode may, for instance, represent one out of the numerous wireless equipments operating in the industrial, scientific and medical (ISM) frequency band, such as Bluetooth, Wi-Fi and Digital Enhanced Cordless Telecommunications (DECT), or any other wireless system. Thus, for instance, said first mode may represent a wireless network having a decentralized radio management.

As depicted in FIG. 1, it is determined (step 110) for each of at least one channel of said plurality of channels whether interference occurs between the first mode and the second mode when the first mode uses the respective channel of said at least one channel. For instance, said interference may be caused by transmission via the first antenna 415 in the first mode and coupling through the second antenna 425 in the signal path of the second mode and/or vice versa.

This interference between the first mode and the second mode may, for instance, be determined by means of a practical measurement of the interference between the first mode and the second mode in the device 400, but any other suited way to determine the interference may also be applied. For instance, the frequency distance between the respective channel of said at least one channel and the frequency band of the second mode may be used as a kind of indicator for the interference between the first and second mode when this respective channel is used in order to determine said interference. Said practical measurement may be performed by said control unit 430.

The channels that have been determined not to cause interference then are stored in a list of preferable channels (step 120). The term interference is understood in such a way that those channels that cause less or no interference between the first mode and the second mode are stored in said list of preferable channel (i.e., an interference threshold, which may vary on the requirements of the first mode and/or the second more and/or on the requirements of the applications running on said modes, may, for instance, be used to determine and to store the channels causing interference below said threshold into the list of preferable channels).

Thus, for instance, those channels of said at least one channel having a safe frequency distance (SFDD) from the frequency band of said second mode may be determined and stored in said list or preferable channels.

This list of preferable channels can be used by the multimode device 400 in order to select one of the channels in this list as an access channel in order to establish a communication in the first mode when the second mode is active simultaneously. Thus, inter-mode interference caused by the device 400 being driven in both the first mode and the second mode simultaneously can be avoided or minimized by means of said list of preferable channels associated with the first mode in order to determine an access channel for establishing a communication in the first mode when the device 400 is simultaneously driven in the second mode.

Furthermore, in the case where said second mode is non-active, another access strategy to find an access channel in the first mode may be used. For instance, a further list of channels comprising the last successful accessed channels of said first mode may be used to select an access channel for establishing a communication in the first mode.

The explanations and advantages given with respect to the first exemplary embodiment of a method according to the present invention also hold for the following exemplary embodiments of methods according to the present invention.

FIG. 2 depicts a second exemplary embodiment of a method according to the present invention, which is based on the first exemplary embodiment of the method depicted in FIG. 1.

For instance, at least one channel of said plurality of channels associated with the first mode is selected. This may depend on the actual status of the first mode. For example, in the case where said first mode represents a cellular communication function, said at least one channel may be represented by those channels being currently available for a communication to a base station or any other station of said cellular system

At step 210, one of said at least one channel is selected, and it is determined in step 220 whether interference occurs between the first mode and the second mode when this selected channel is used by the first mode as explained with respect to step 110 of the first exemplary method.

Then, depending on this determination, it is decided whether interference occurs or not at step 230, and if no interference occurs between the first and second mode for this selected channel, then this channel is stored in the list of preferable channels (step 240), and the method proceeds with deciding (step 250) whether there exists another channel of said least one channel to be examined. If there exists another channel to be examined, then the method may proceed at step 210, otherwise it may stop.

In the case where it is decided at step 230 that interference occurs, the method may directly proceed to step 250, or, optionally, the selected channel may be stored in a list of interference channels at optional step 245 (indicated by the dashed box 245). This allows classifying channels associated with the first mode into a list of preferable channels and a list of interference channels. Thus, for instance, those channels of said at least one channel having a safe frequency distance (SFDD) from the frequency band of said second mode may be determined and stored in said list of preferable channels and those without SFDD from the frequency band of said second mode may be determined and stored in said list of interference channels.

Furthermore, for instance, the channels in said list of preferable channels and said list of interference channels may be adjusted between the different lists according to different application scenarios. For instance, when the second mode of the device 400 is shutdown, all channels may be belong to the list of preferable channels.

The explanations and advantages given with respect to this second exemplary embodiment of a method of the present invention also hold for the succeeding exemplary embodiments of methods of the present invention.

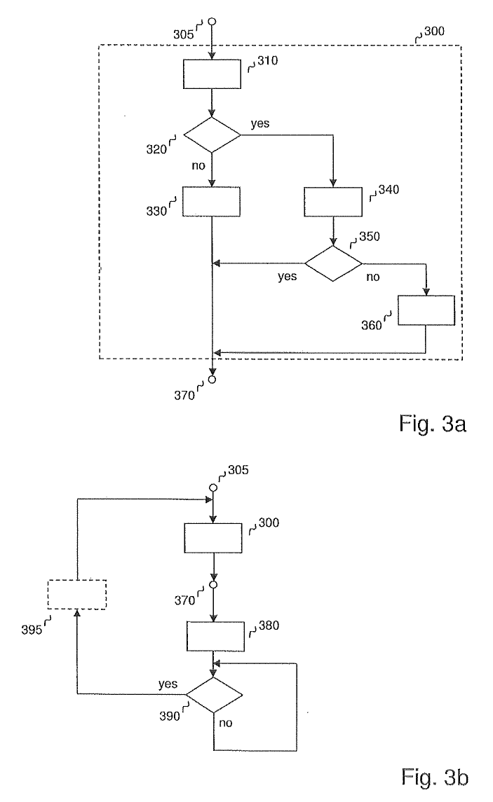

FIG. 3a depicts a third exemplary embodiment of a method according to the present invention, which may, for instance, be applied in conjunction with the first exemplary embodiment or the second exemplary embodiment of the method according to the present invention.

This third exemplary embodiment of a method is performed to identify a suitable channel of said plurality of channels in order to establish a communication in the first mode by the multimode device 400 via this suitable channel. It is assumed that said list of preferable channels has already been generated when starting this third exemplary method at point 305.

In step 310, it is determined whether the second mode of the device 400 is active. If this is not the case, then it is decided at step 320 to proceed with a single-mode communication acquisition (step 330) in order to establish a communication in the first mode by device 400. For instance, this single-mode communication acquisition may use a list of channels comprising channels that have been used for earlier communications in the first mode, but any other suited access method may be used to identify a suitable channel out of said plurality of channels associated with said first mode. As another example, in the case where the list of interference channels also has been generated, a list of channels comprising both the channels of the list of preferable channels and the channels in the list of interference channels may be used at single-mode communication acquisition 330. For instance, this single-mode communication acquisition 330 may be performed by a standardized acquisition procedure of the first mode.

Thus, in this single-mode (i.e., with non-active second mode), the entire performance of the first mode communication system is not influenced since the device still can utilize the channels of said plurality of channels near the frequency band of the second mode.

In the case where it is determined that the second mode of the device 400 is active (i.e., the device will now be driven in a multimode status), it is decided at step 320 to proceed with first searching the list of preferable channels for identifying a suitable channel in order to establish a communication in the first mode at step 340.

Thus, according to the present invention, the device first searches those channels associated with the first mode that have been determined not to interfere with the second mode of the device 400. If one of the channels of said list of preferable channels represents a channel suitable for an access in the first mode at step 350, then this channel is selected, and the third exemplary method depicted in FIG. 3a proceeds from step 350 to finish at point 370.

Thus, this selected channel may be used for access in the first mode. Accordingly, the serious inter-mode RF interference between the first and the second mode caused by the device 400 can be overcome with a minimum complexity and cost since this selected channel does not interfere with the second mode.

Furthermore, if the search for a suitable channel in the list of preferable channels during step 340 is not successful (i.e., no channel of this list can be used for a successful access in the first mode, which may, for instance, be caused by the fact that no channel in the list of preferable channels is available at the moment), then it is decided at step 350 to proceed with an extended search (step 360) for a suitable channel in order to establish a communication in the first mode. For instance, this extended search 360 may comprise searching the list of interference channels for identifying a suitable channel, and/or it may comprise searching other channels of said plurality of channels associated with the first mode.

FIG. 3b depicts a fourth exemplary embodiment of a method according to the present invention. This fourth exemplary method is configured to establish a communication in the first mode by the device 400 based on the identified suitable channel at step 380, wherein, for instance, the third exemplary method as described above may be used to identify said suitable channel as indicated by reference sign 300 in FIG. 3b.

After the communication in the first mode has been established (step 380), it may be determined during step 390 whether there is the necessity for determining a new channel for performing communication in the first mode. For example, the signal level or signal-to-noise-ratio (SNR) may be checked, and when the signal level or SNR falls under a predetermined level, then it is decided at step 390 to re-perform the identifying of a new suitable channel (step 300) as explained above in the third exemplary method depicted in FIG. 3a. Or, for instance, a change regarding the operating state of the second mode and/or the first mode at the device may trigger the necessity for identifying a new suitable channel at step 390. For example, the use of a new different frequency band in the second mode, or activating/deactivating the second mode may represent such a change regarding the operating state of the second mode.

Furthermore, for instance, before said identifying of a new suitable channel is performed, a re-organization of the list of preferable channels and the list of interference channels may be carried out as indicated by optional step 395 in FIG. 3b. This re-organization may comprise adjusting at least one channel between the list of preferable channels and the list of preferable channels, which may depend on variations of an operating state of the second mode or on other operating changes like different applications. Furthermore, for instance, said optional step 395 may comprise a complete re-determination of the list of preferable channels and the list of interference channels by means of the second exemplary method. Thus, during changes in operating states of the device, the list of preferable channels and the list of interference channels may be adopted and/or adjusted, and the channel used for communication in the first mode can be changed due to the variations in the operating state.

FIG. 5 depicts an illustration of an exemplary handover between different channels in the first mode according to the present invention due to the geographical position changes of the multimode wireless device. This handover, for example, may be performed by the fourth exemplary embodiment of a method according to the present invention mentioned-above.

It is now assumed without any restrictions that the first mode represents a cellular wireless function (e.g., a Time-Division—Synchronous Code Division Multiple Access (TD-SCDMA) having three frequency bands: 1880-1920 MHz (Band I), 2010-2025 MHz (Band II) and 2300-2400 MHz (Band III)). The first cell 510 is associated with the first frequency band I, and the second cell 520 is associated with the third frequency band. Thus, in the intersection 515 of both the first cell 510 and the second cell 520, the first band I as well as the third band III represent suitable channels for establishing a communication in the first mode, whereas in section 511 of the first cell, only the first band I represents a suitable channel, and in section 521 of the second cell 520, only the third band III represents a suitable channel.

Furthermore, the second mode of the device 400 may be assumed to represent a non cellular wireless function (e.g., ISM) having its frequency band adjoining the third frequency band III of the TD-SCDMA system. Thus, it is determined that the first band I represents a channel comprised in the list of preferable channels, and it is determined that the third band III represents a channel comprised in the list of interference channel due to the adjoining frequency bands of the second wireless mode and the third frequency band III.

If the second mode is activated now, the above mentioned channel handover would be sub-optimal due to inter-mode interference caused by selecting the third band III in intersection 515. According to the present invention, when a TD-SCDMA/ISM multimode terminal user walks along a route from point 530 to point 540, the cellular access channel will always become the first band I in the intersection 515 since it would be selected as suitable channel of the list of preferable channels during step 340 depicted in FIG. 3a. Thus, the inter-mode interference can be prevented in the intersection 515.

The invention has been described above by means of exemplary embodiments. It should be noted that there are alternative ways and variations which are obvious to a skilled person in the art and can be implemented without deviating from the scope and spirit of the appended claims.

Furthermore, it is readily clear for a skilled person that the logical blocks in the schematic block diagrams as well as the flowchart and algorithm steps presented in the above description may at least partially be implemented in electronic hardware and/or computer software, wherein it depends on the functionality of the logical block, flowchart step and algorithm step and on design constraints imposed on the respective devices to which degree a logical block, a flowchart step or algorithm step is implemented in hardware or software. The presented logical blocks, flowchart steps and algorithm steps may, for instance, be implemented in one or more digital signal processors, application specific integrated circuits, field programmable gate arrays or other programmable devices. The computer software may be stored in a variety of storage media of electric, magnetic, electromagnetic or optic type and may be read and executed by a processor such as a microprocessor. To this end, the processor and the storage medium may be coupled to interchange information, or the storage medium may be included in the processor.

What is claimed is:

1. A method for a device, wherein the device is configured to communicate in a first mode of wireless communication and a second mode of wireless communication simultaneously, said first mode being associated with a plurality of channels, the method comprising:
determining for each of at least one channel of said plurality of channels whether interference occurs between the first mode and the second mode when the first mode uses the respective channel of said at least one channel; and
storing the channels which have been determined not to cause interference in a list of preferable channels.

2. The method according to claim 1, wherein said determining is based on measuring an interference between the first mode and the second mode caused by the device for each of said at least one channel.

3. The method according to claim 1, wherein said second mode represents a non-cellular communications mode.

4. The method according to claim 1, wherein said first mode represents a cellular communications mode.

5. The method according to claim 1, further comprising storing the channels which have been determined to cause interference in a list of interference channels.

6. The method according to claim 5, further comprising adjusting at least one channel between the list of preferable channels and the list of interference channels during operation of the device.

7. The method according to claim 1, further comprising identifying a suitable channel from said plurality of channels in order to establish a communication in the first mode via this suitable channel, wherein said identifying comprises:
determining whether the second mode is active, and
if the second mode is determined to be active, then searching the list of preferable channels to identify a suitable channel in a channel selection/re-selection procedure of the first mode, and, only when no channel of the list of preferable channels is suitable, searching the list of interference channels to identify a suitable channel in a channel selection/re-selection procedure of the first mode.

8. The method according to claim 7, wherein said identifying further comprises:
if the second mode has been determined to be non-active, then identifying a suitable channel in order to establish a communication in the first mode via this suitable channel by searching one of the following list of channels:
a list of channels comprising both the channels in the list of preferable channels and the channels in the list of interference channels, and
a list of channels comprising channels which have been used for earlier communications in the first mode, and
a further list of channels comprising at least one of said plurality of channels.

9. The method according to claim 7, wherein said first mode represents a cellular communications mode and said channel selection/re-selection procedure represents a cell selection/re-selection procedure.

10. The method according to claim 7, further comprising establishing a communication in the first mode based on said identified suitable channel.

11. The method according to claim 10, further comprising re-performing said identifying of a suitable channel during operation in the first mode, and when a new suitable channel is identified, switching to the new identified suitable channel in the first mode.

12. A computer program product tangibly embodied in an information carrier, the computer program product comprising instructions that, when executed, cause at least one processor to perform operation of a method for a device, wherein the device is configured to communicate in a first mode of wireless communication and a second mode of wireless communication simultaneously, said first mode being associated with a plurality of channels, the method comprising:
determining for each of at least one channel of said plurality of channels whether interference occurs between the first mode and the second mode when the first mode uses the respective channel of said at least one channel; and
storing the channels which have been determined not to cause interference in a list of preferable channels.

13. A computer program operable to cause a processor to perform a method for a device, wherein the device is configured to communicate in a first mode of wireless communication and a second mode of wireless communication simultaneously, said first mode being associated with a plurality of channels, the method comprising:
determining for each of at least one channel of said plurality of channels whether interference occurs between the first mode and the second mode when the first mode uses the respective channel of said at least one channel; and
storing the channels which have been determined not to cause interference in a list of preferable channels.

14. A device capable to communicate in a first mode of wireless communication and a second mode of wireless communication simultaneously, said first mode being associated with a plurality of channels, the device comprising a control unit configured to
determine for each of at least one channel of said plurality of channels whether interference occurs between the first mode and the second mode when the first mode uses the respective channel of said at least one channel; and to
store the channels which have been determined not to cause interference in a list of preferable channels.
